(19) United States
(12) Patent Application Publication
(10) Pub. No.: US 2002/0116257 A1
(43) Pub. Date: Aug. 22, 2002

(54) ON-LINE ADVERTISEMENT ENHANCEMENT AND INCENTIVE SYSTEM

(76) Inventor: ARTHUR HELBIG, ELLICOTT CITY, MD (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/312,697

(22) Filed: May 17, 1999

(51) Int. Cl. G06F 17/60

(52) U.S. Cl. 705/14

(57) ABSTRACT

An electronic on-line advertisement enhancement and incentive method and apparatus which offers an incentive to an incentive user over an electronic computer network is provided according to a first aspect of the invention. The method includes the steps of electronically awarding an incentive to an incentive user over the electronic computer network, the incentive preferably being in the form of an electronic incentive awarded by an incentive issuer, electronically storing over the network the incentive in a incentives administration server, and electronically redeeming over the network the incentive at the incentive user's discretion.

Additional aspects of the invention include associating logo representations of incentives to be awarded with on-line advertisements and thereby encouraging incentive users to click through such advertisements to incentive issuer sites, where, on such issuer sites, they may select electronic incentive symbols and be awarded incentives or be awarded incentives for purchasing.

### BACKGROUND OF THE INVENTION

1. Field of the Invention

The present invention relates generally to an online advertisement enhancement and incentive system, and more particularly to such an on-line system that enhances the value of on-line advertising by providing increased advertising click through, increased electronic commerce site exploration and increased purchases through the electronic display, awarding, storage, and redemption of consumer incentives.

2. Description of the Background Art

On-line or electronic commerce (e-commerce) is the practice of conducting commerce over an electronic computer network, such as the Internet. For example, individuals seeking to purchase particular goods or services visit a merchant's site on the network, e.g., a Web site, and view the goods or description of services offered for sale, possibly purchasing same. E-commerce or on-line “shopping” is growing rapidly, with on-line sales transactions projected to reach $17.5 billion by the year 2001. Current estimates are that in the United States alone, over 70 million individuals have Internet access, with projected users soon to reach on the order of 150 million.

With the growth of e-commerce, has come the growth of advertising programs for e-commerce sites. Advertising opportunities include traditional television, radio and print media ads; Internet banner advertising on merchant sites and on major Internet portals such as Yahoo!, MSN and AOL; and other on-line advertising programs. Advertising networks and advertising campaign management firms have arisen to plan and execute on-line advertising programs. Such companies are essentially “middlemen” between ad agencies and merchants; they plan, coordinate and manage Internet advertising campaigns or otherwise provide advertising exposure to networks of content-specific sites. The major Internet portals also provide various advertising opportunities, delivering ads to consumers based not only on demographics and purchasing behavior, but also based on consumers' seeking sites to visit or consumers' entry onto related sites.

Additionally, on-line merchants recognize the benefit of recording buyer purchasing patterns and preferences in order to more effectively communicate with customers and target receptive buyers. As a result, there is a heightened focus on on-line information gathering and tracking.

As part of their advertising and marketing programs, on-line merchants are engaged in continual efforts to give customers and potential customers incentives to both visit and browse their on-line e-commerce sites and to purchase their products and services. Various consumer incentive programs have existed, including cash discounts, price cuts, cash or other currency-based giveaways, redeemable coupons, free merchandise or services, points-based programs such as frequent flyer programs, and sweepstakes, to name a few. Such known incentive programs have suffered, however, from various disadvantages for consumers, merchants and the entities who redeem incentives. For example, purely paper-based coupons, stamps, or certificates become bulky and cumbersome to accumulate and use, and they can be easily misplaced. Consumer and redeemer handling of such incentives during purchasing transactions, including the need for manual recording into customer accounts, has been inconvenient and can slow sales transactions. Purely paper-based incentives have also typically only rewarded consumers for actual purchases, with no reward for simply visiting a merchant's place of business. Moreover, such programs typically fail to provide valuable demographic information about consumers or only gather demographic information at the time of redemption by manual recording.

Certain consumer incentive programs have attempted to combine electronic or on-line features with familiar paper-based features, such as by providing printed coupons or certificates which have been chosen by a consumer on-line. These programs may ease a storage problem by only printing coupons as desired, but do not address the above-discussed problems with paper-based incentives for the merchant or redemption authority. In addition, such dispenser-generated incentives may not award the desired incentive unless a consumer specifically seeks out the incentive, thereby making it inefficient for a consumer to accumulate desired incentives and hampering overall access to incentives.

Certain known on-line advertising/incentive programs attempt to attract the attention of Internet users by offering cash or currency-based incentives when consumers pay attention to merchant messages. These programs typically coordinate banner-type campaigns that offer users small amounts of cash or cash substitutes for clicking on a banner that presents a merchant's desired message about a product or service. The programs can suffer, however, from drawbacks related to difficulties in motivating consumers with small amounts of currency, i.e., consumers may not be sufficiently attracted to receiving a dollar in cash or a one dollar value coupon. They also, as do most on-line advertising/incentive programs, primarily rely on available banner-type promotions (where a consumer's attention must be directed to read a particular promotional message). Although Internet banner-type advertising is a popular means for disseminating information to consumers about merchant's products and services, currently available banner programs have proven to be somewhat ineffective in actually producing Internet site visitors, while at the same time being expensive. Consumers have typically found known banner ads distracting or disruptive, and they have not been motivated to view the ad. Many consumers currently ignore banner ads, never “clicking” on them at all when visiting, for example, a portal site.

Additionally, there exist on-line incentive programs that are based on the awarding of points which can be accumulated and redeemed for such items as gift certificates, long distance phone services and frequent flyer mileage. These programs typically require consumers to first visit (or be contacted by and then visit) the incentive program site in order to receive any points. Once at the program site, the points are awarded when a consumer clicks on a banner ad displayed on the program site. That click then transfers the consumer to the topic site mentioned in the banner. There may be no award opportunities, however, once the consumer has arrived at the merchant site.

Incentive programs of this type suffer from various drawbacks. Consumers may be averse to having to first visit the incentive program site and to receiving numerous contacts from the site. Also, requiring a consumer to first visit the program site in order to be awarded any incentives introduces an unnecessary hurdle between consumer visits to merchant sites. These programs also typically attempt to only send consumers information that their profile indicates they desire and thus can further limit access to merchant exposure. Moreover, by awarding the incentive when the banner ad appearing on the incentive program site is clicked (rather than providing award opportunities on the merchant sites), there is no incentive for consumers, once they are on the merchant site, to spend any significant time on or browse the merchant site.

Further limitations of current on-line advertising/incentive programs arise from the fact that such programs typically focus on the Internet user as the primary customer and, therefore, attempt to bring the Internet user first to the incentive program Web site where they then provide incentives for the Internet user to visit their partner merchant Web sites (or purchase products or services on those sites). Available programs in effect thus create incentive-based portals, using incentives or rewards to attract consumers to their incentive site and then driving those consumers to merchant sites. Such programs typically make no attempt to work with Internet advertising firms or existing Internet portals to actually enhance the value of the advertising.

What is needed, therefore, is an on-line advertisement enhancement and incentive system where incentives are electronically displayed, rewarded, stored and redeemed without the shortcomings and disadvantages of existing programs. The present invention meets these needs by providing a unique, electronically or physically dispensed, and electronically redeemable incentive through a computer-based system that utilizes public computer networks such as the Internet. The invention provides a means and method for Internet advertisers (whether they be ad management or network firms, portals or merchants) to enhance the value of on-line advertising by providing increased advertising click through, increased Web site exploration and increased purchasing. The invention uniquely motivates consumers not only to read banner ads and visit merchant sites, but to spend time at or browse a merchant site, read merchant messages, visit multiple portions of the site, request information about products and actually purchase products.

Objectives of the invention include, but are not limited to: a) enhancing banner advertisements and other on-line advertisements by providing an incentive logo to be displayed on or in connection with such advertisements and, thereby, enticing users (consumers) to click on the advertisement because the users recognize that the display of the incentive logo indicates that the merchant site mentioned in the advertisement offers unique, redeemable incentives; (b) providing a new opportunity to present banner-type advertisements by presenting a pop-up window each time an incentive is issued to a user, the window presenting messages to the user and thus presenting an opportunity for high-volume Internet advertisement placement; (c) providing a total system solution and services to Internet merchants that creates an incentive for Internet users to visit selected merchant Web sites and to purchase product or services from those merchants; (d) permitting the consumer to easily locate and acquire incentives electronically via a computer network and automatically record them in a centralized computer database in their personal account; (e) permitting consumers to acquire physical representations of printed incentives and registering them into their personal on-line account via a computer network; (f) permitting consumers to easily redeem the accumulated incentives in an on-line system of a computer network, picking from computerized lists of products from vendors participating in the incentive program; (g) permitting product vendors who provide products for redemption to receive consumer orders automatically routed to them for immediate fulfillment; (h) permitting consumers to easily access on-line lists of incentive issuers who participate in the incentive program; (i) rewarding incentive issuers (whether they be merchants or advertisers) with valuable consumer demographic data accumulated from consumers who receive incentives; and (j) rewarding product vendors with valuable consumer demographic data accumulated from consumers who chose their products in return for redeemed incentives.

Additional objectives of the invention include, but are not limited to, providing a database of user preferences and demographic data and the means to utilize same so that the incentive system can uniquely identify users of the system as they exercise the system functions thereby modifying responses from the system to consumers to increase the effectiveness of advertising into enhanced consumer enjoyment of the system; providing a fully scalable computer infrastructure and system design that is capable of rapidly expanding to support growth rates employing component object architecture that divides the system into encapsulated functions; providing a computer service department that aids consumers using an incentive administration service system with the ability to easily service computer accounts via on-line access through public computer networks; providing various security measures and controls and misuse detectors to limit fraudulent use of the incentives; providing automated tracking sales of incentives to issuers from a central incentive dispensing authority or through sellers who first purchase incentives from the central incentive dispensing authority; and providing an easy and efficient means for users to update their personal and demographic information stored in an incentive administration server.

### SUMMARY OF THE INVENTION

An electronic on-line advertisement enhancement and incentive system which offers an electronic incentive to a user of an electronic computer network is provided according to a first aspect of the invention. The system includes an incentives administration server, including 1) an input/output device, 2) an electronic computer network interface connected to the electronic computer network, 3) an incentive issuer database, 4) an incentive user database, 5) an incentive database, and 6) a processor connected to the input/output device, the electronic computer network interface, the incentive issuer database, the incentive user database, and the incentive database and operative to control an issuance, award, storage, and redemption of the incentives over the electronic computer network, and at least one incentive issuer node, including an electronic incentive symbol to be displayed to users accessing the at least one incentive issuer node, the electronic incentives symbol representing the at least one incentive issuer node's participation in the system.

An electronic incentive for use on an electronic computer network is provided according to a second aspect of the invention. The electronic incentive includes an electronically stored incentive user identifier, an electronically stored incentive issuance date and time, and an electronically stored incentive symbol identifier.

A printed incentive for use on an electronic computer network, the printed incentive capable of being converted into an electronic incentive, is provided according to a third aspect of the invention. The printed incentive includes a ticket having an electronically stored incentive user identifier, an electronically stored incentive issuance date and time, an incentive serial number printed on said incentive, and an incentive lot number printed on said incentive.

An electronic advertisement enhancement and incentive method which offers an incentive to an incentive user over an electronic computer network is provided according to a fourth aspect of the invention. The method includes the steps of electronically awarding an incentive to the incentive user over the electronic computer network, the incentive being awarded by an incentive issuer, electronically storing over the network the incentive in an incentives administration server, and accessible over the electronic computer network, and electronically redeeming over the network the incentive at the incentive user's discretion.

An electronic incentive method which offers an incentive to an incentive user over an electronic computer network is provided according to a fifth aspect of the invention. The method comprises the steps of electronically registering over the network an incentive user and granting the incentive user an electronic incentive account in an incentives administration server, electronically displaying over the network the incentives at a site of an incentive issuer, electronically awarding over the network a predetermined value of incentives to the incentive user upon access of the site of the incentive issuer and upon selection of a displayed electronic incentive symbol, and electronically crediting over the network the electronic incentive user's account in the incentives administration server, wherein the incentive user may accumulate and redeem the incentives. The incentive user's account is immediately credited and the transaction is immediately visible to said user.

An electronic incentive method which offers an incentive to an incentive user over an electronic computer network is provided according to a sixth aspect of the invention. The method includes the steps of distributing (selling) the electronic incentives to an incentive issuer, recording, in an incentives administration server, data, identifying the incentives that were distributed, electronically registering over the network an incentive user and granting the incentive user an electronic incentive account in a incentives administration server, displaying a representation of the incentives at a site of an incentive issuer, electronically awarding over the network a predetermined value of incentives to the incentive user upon access of the site of the incentive issuer and upon selection of a displayed electronic incentive representation, electronically crediting over the network an electronic incentive users account of the registered incentive user in the incentives administration server, and electronically redeeming the incentives from an incentive issuer, over the network, wherein the registered incentive user may accumulate and redeem the incentives.

An electronic incentive method permitting an incentive user to obtain electronic incentives from an incentive issuer is provided according to a seventh aspect of the invention. The method includes the steps of selecting an electronic incentive symbol on the incentive issuer's site, obtaining an incentive user's information from a computer network browser of the incentive user, determining whether the incentive issuer has the electronic incentives available to issue, determining whether the incentive user is eligible to receive the electronic incentives by verifying that the incentive user is a registered incentive user, determining whether an incentive user identifier has been received from the browser of the incentive user, prompting for the incentive user identifier if the incentive user identifier has not been received, and adding a predetermined award value of the electronic incentives to a cumulative incentives total of the incentive user.

The above and other features and advantages of the present invention will be further understood from the following description of the preferred embodiment thereof, taken in conjunction with the accompanying drawings.

### BRIEF DESCRIPTION OF THE DRAWINGS

FIG. 1 shows a first embodiment of an electronic incentive system of the present invention;

FIG. 2 shows a block diagram of the overall apparatus implementation;

FIG. 3 shows a detailed block diagram of an incentives administration server of the present invention;

FIG. 4 shows one embodiment of an electronic incentive record stored in the stamps administration server;

FIG. 5 shows one embodiment of a printed incentive record stored in the incentives administration server;

FIG. 6 shows a flowchart of a first embodiment of the present invention;

FIG. 7 shows a flowchart of a second embodiment of the present invention;

FIG. 8 shows a screenshot of a main menu screen displayed to an incentive user in accordance with the present invention;

FIG. 9 shows a screenshot displayed to an incentive user having various display buttons which can be selected by the incentive user;

FIG. 10 shows a flowchart of a third embodiment of the method of the present invention;

FIG. 11 shows a display screenshot illustrating an electronic shopping cart;

FIG. 12 shows a flowchart of a fourth embodiment of the method of the present invention;

FIG. 13 shows a flowchart of an embodiment of an incentive award method;

FIGS. 14A and 14B show representative electronic incentive symbols and logo designs in accordance with the invention;

FIG. 15 is a display screenshot showing an incentive user's account status; and

FIG. 16 shows a flowchart of a printed incentive process for entering a printed incentive into the electronic incentive system.

### DETAILED DESCRIPTION OF THE PREFERRED EMBODIMENTS

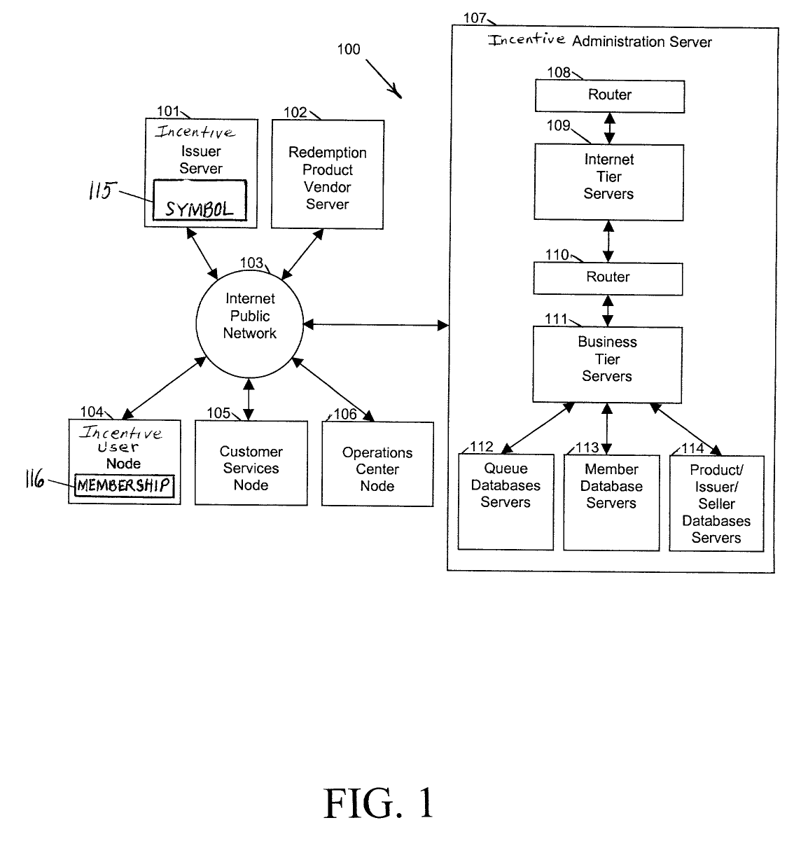

A preferred embodiment of the electronic incentive system 100 of the present invention is shown in FIG. 1. In the preferred embodiment, the particular incentive being awarded and redeemed may be in the form of a certificate, voucher, stamp, sticker, fanciful or arbitrary object or any other similar representation of an available incentive. The use of any particular form of an incentive in this description is exemplary only, and specifically contemplates all other similar incentive representations.

In the electronic incentive system 100, the network nodes: 104, which represents a consumer, incentive user node; 105 which represents a customer services node; and 106 which represents an incentive administration operations center, are defined as general-purpose digital computers or similar devices connected to a public computer network 103, which, in the preferred embodiment, is the Internet. The connection may be made over digital and/or analog lines, utilizing, for example, dial-up telephone lines or direct phone lines through the public switched telephone network (PSTN) or integrated services digital network (ISDN), fiber optic cable access, cable television coaxial cable access (such as a cable modem), a digital subscriber link (DSL) line, etc. Any node in the electronic incentive system 100 may communicate using Internet Protocol (IP). Internet Protocol (IP) RFC 791, Transmission Control Protocol (TCP) RFC 793, the TCP/IP protocol suite which is described in RFC (Request For Comments) 1122, and associated other RFCs mentioned below are all available from SRI International, DDN Network Information Center, Room EJ291,333 Ravenwood Avenue, Menlo Park, Calif. 94025. However, other communication devices, such as personal communicators coupled to a public computer network through wireless transmissions are contemplated as being within the scope of the present invention.

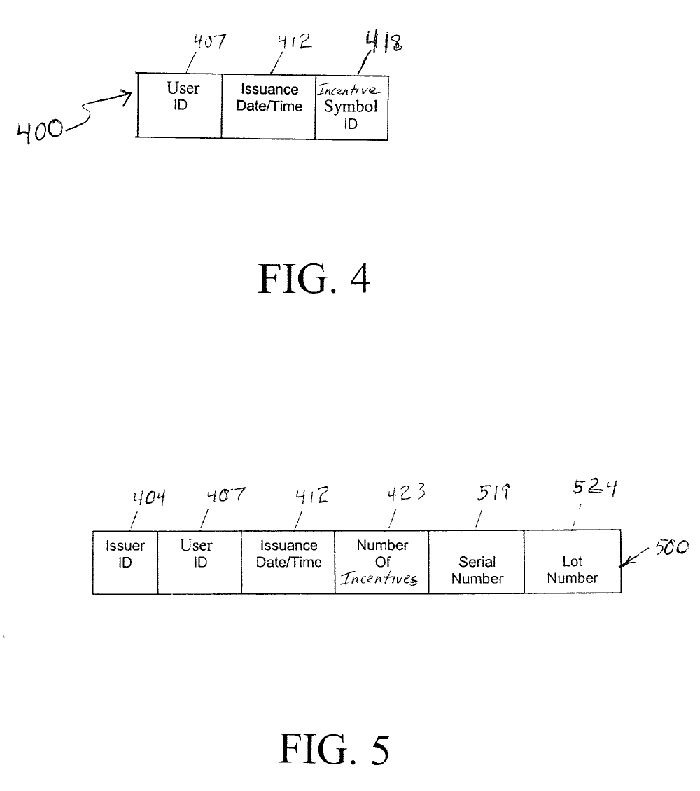

As shown in FIG. 1, nodes 104, 105 and 106 are coupled to an incentive administration server 107 and an incentive issuer server 101 via the Internet 103. The administration server 107 may be a single general-purpose computer or an interconnected collection of general-purpose digital computers which serve as an “Internet host” (e.g., appearing to incentive users as an incentive program Web site) as described in the Internet Protocol RFC 791. The administration server 107 contains records of electronic incentives 400 (FIG. 4), records of printed incentives 500 (FIG. 5), and a member database 113 which tracks individual incentive users registered with the administration server 107. The administration server 107 also includes a product/issuer database 114 which tracks the incentive issuers who dispense incentives (e.g., merchants or advertisers), tracks products that are available to incentive users for redemption of their accumulated incentives, and tracks vendors who provide the products for redemption. The administration server 107 further includes a queue database 112 which tracks various transactions that require communication and routing within the administration server 107 and to other systems.

In addition, the incentive administration server 107 also includes one or more Internet tier servers 109, which are general-purpose digital computers that respond to requests for interactive communication. Administration server 107 optionally includes a router 108. The router 108 is an electronic device designed to optimize throughput by evenly distributing the volume of incoming communications messages amongst the Internet tier servers 109. Administration server 107 also includes one or more business tier servers 111, which are general-purpose digital computers that execute the business object modules and implement the computerized functions and methods of stamp administration. The router 110 is an optional electronic device designed to evenly distribute the volume of incoming requests for stamp administration processing from the Internet tier servers 109.

Also shown in FIG. 1 is an incentive issuer server 101 which represents the independently owned and operated Internet sites of those parties, such as merchants, who enter into agreements with the incentive program operator to become issuers of incentives. The issuer server 101 includes at least one incentive symbol 115 which could be an electronic depiction of a stamp or other incentive voucher, wherein an incentive user may be awarded a predetermined amount of incentives by clicking on the symbol 115.

In contrast to related art systems, clicking on the incentive symbol 115 is simple yet flexible. As described below, the method of the present invention allows the incentive issuer (who may be the topic site of an on-line advertisement) to disperse electronic incentive symbols (buttons) throughout their site in as many places and with as many different parameters as they wish. Each symbol site can have its own rules with regard to how many incentives are issued for a user's clicking on the symbol and how often. This encourages the incentive user to extensively browse the incentive issuer's site, spending a lot more time at the site than may occur with related art schemes.

Network node 104 may be one or more incentive user or potential user sites. Node 104 may connect to various other components of the electronic incentive system 100 via the public network 103. These users are typically consumers who are members of the incentive program administered by server 107 (possibly in combination with customer services node 105 and operations center node 106, described below). These consumer members visit merchant sites (e.g., node 101), collecting incentives at such sites and accessing, via the network, the storage and redemption features, among others, administered by administration server 107. User node 104 may include an optional membership symbol 116, whereby an individual who is not yet a member of the incentive program (and thus not yet an incentive user) and who has visited node 104, may click on the membership symbol 116 and be connected to the electronic incentive system 100. As a reward for this referral of a potential incentive user, the user at node 104 may be awarded incentives when the potential new member clicks on the membership symbol 116.

Additionally, FIG. 1 shows a redemption product vendor node 102 which represents the independently owned and operated Internet sites of those parties who enter into agreements (e.g., with the operators of the incentive administration site) to become providers of products that are redeemed by consumers with incentives. As is more fully discussed below, users may redeem their incentives for products using the redemption product vendor server 102 to generate orders for products. Specifically, the user 104 interacts with the administration server 107 to see products available for redemption, to choose one or more products, and submit orders for the chosen product. Upon receiving completed orders, the administration server 107 then employs the queue server 112, which stores the information needed to fulfill the orders, to interact with (transmit the order to) the redemption product vendor server 102 to complete the order fulfillment process. In this embodiment, the user 104 does not communicate directly with the redemption product vendor server 102 in the order process. The user 104 can, however, navigate to a redemption product vendor server 102 site through hyperlinks on the administration server site 107.

FIG. 1 also shows a customer services node 105 and an operations center node 106, which may be general-purpose digital computers. The customer services node 105 includes one or more computers used by customer relations personnel to access the incentive administration server 107 on behalf of incentive users who make inquiries about their accounts (preferably via telephone or E-mail). The operations center node 106 includes one or more computers used by operations personnel to periodically maintain the information in the databases of the administration server 107, including the actions of adding, changing and deleting various data records pertaining to incentive users, incentive issuers, entities who distribute or sell incentives to issuers, and redemption product vendors. In the embodiment of FIG. 1, the nodes 105 and 106 could be administered by outsourced personnel separate from the administration site 107; in an alternative embodiment the functions of nodes 105 and 106 could be accomplished by administration server 107.

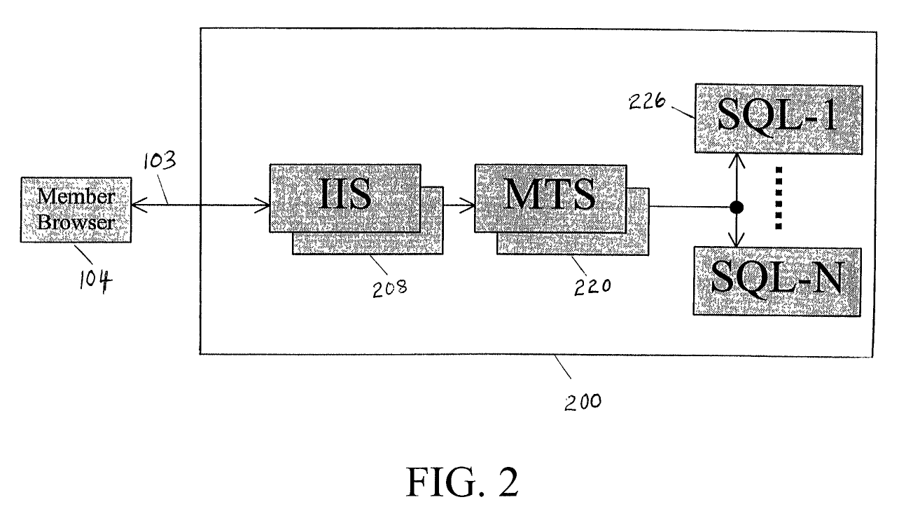

FIG. 2 shows an overview of a typical computer architecture which may be used for the electronic incentives administration server node, which is an N-tier-type architecture. The electronic incentive administration server node 200 includes an incentive user browser 104, an Internet information server tier 208, a MICROSOFT Transaction Server tier 220, and a plurality of SQL Server databases 226 (a database administration system also available from Microsoft Corporation). The user browser 104 is an Internet browser, and may be any type of common Internet browser that gives suitable Internet access. The Internet information server tier 208 processes all of the requests from incentive users 104, customer service node 105, administration operations center 106, and incentive issuers 101. Requests fall into the two main categories, namely, requests by users for new on-line electronic incentive issues, and home site processing wherein users can find new sites offering incentives and/or redeem incentives that they have accumulated. Scalability in this tier will be handled via routers that will assign requests to individual Internet information servers 208. The Internet information servers will execute the Active Server Pages (ASP) and HTML (hypertext mode link, a common Internet language) coded pages that support the system. Active Server Pages is a scripting language available from Microsoft that allows developers to program Web site interactions that run under IIS (Internet Information Servers), which, in turn, run under Microsoft NT (New Technology) operating system servers. ASP allows developers to create dynamic web pages as opposed to static ones that are written in HTML. The ASP code dynamically generates HTML pages that are unique to each interaction with a user who is operating a browser 104.

The transaction servers 220 execute the custom objects that implement business rules and access to the administration server 107. The transaction servers 220 are a subset of the administration server 107 which is a collection of various servers, including transaction servers 220. The transaction servers 220 act in conjunction with Internet Information Servers 208 on the graphical user interface (GUI) end and with the SQL server databases 226 on the backend where the SQL server databases 226 reside. The transaction servers 220 are scaled by virtue of their attachment to the Internet information servers 208 that have been scaled via routers. Scaling, therefore, allows the incentives administration server node to be increased in size such that it could handle additional users' requests simultaneously, while retaining the desired functionality. Scaling of the use of Component Object Model (COM) objects is a standard function within the transaction servers 220 through database connection pooling, etc.

The Component Object Model is an industry-standard term used to define the programming practices that allow parcels of computer programs to be used interchangeably through a well-defined, and documented interface that remains unchanged over time, i.e., an object-oriented programming model that defines how objects interact within a single application or between applications. (Connection pooling is a performance optimization based on using collections of pre-allocated resources, such as objects or database connections.)

The SQL server database 226 provides the database function and data storage for large quantities of information, such as incentive user information, incentive issuer information, incentive issuance information, etc. In the preferred embodiment, the SQL server database 226 will be scaled via a separation of accounts by the first two characters of the user membership IDs. This allows distribution of user membership records across a plurality of nodes and a plurality of disk drives.

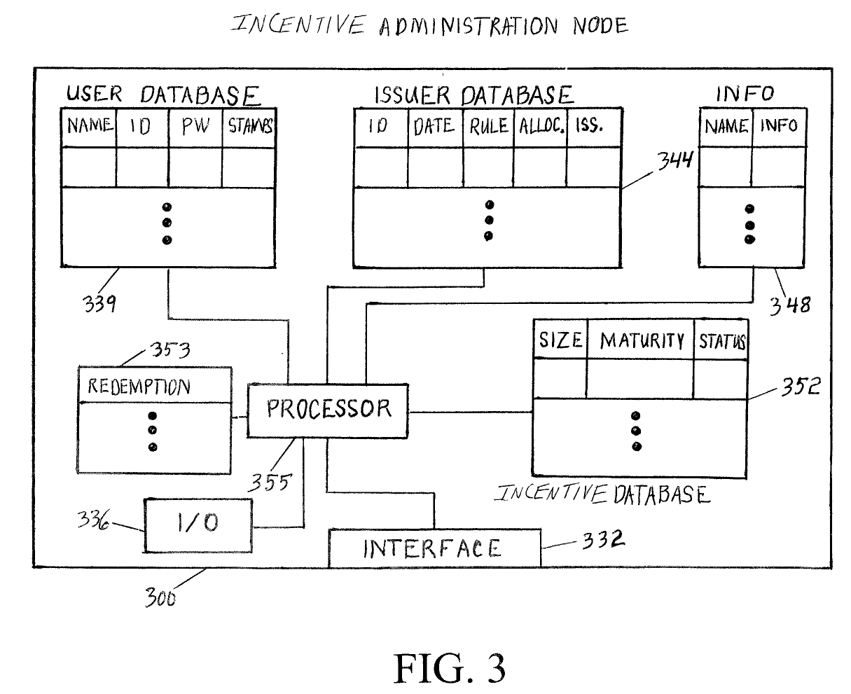

FIG. 3 shows one embodiment of the internal details of an incentive administration server 300. The administration server 300 is a variation on the electronic incentive system as shown in FIG. 1. It is contemplated that the electronic incentive system 100 may be comprised of various independent nodes working together, such as in FIG. 1, or may have all relevant functions in one node, as shown in FIG. 3. It should be understood that the two implementations differ only in the convenience of implementation, and achieve the same function. The administration server 300 includes a computer network interface 332, an I/O (input/output) device 336, an incentive user database 339, an incentive issuer database 344, a user info database 348, an incentive database 352, a redemption database 353, and a processor 355.

The processor 355 is coupled to all of the other above-described components and regulates all activities within the node 300. The processor 355 regulates all operations and conducts communications between the network 103 and any internal data storages, and reads and writes to each individual database according to a control software.

The network interface 332 connects the administration server 300 to the network 103, such as, for example, the Internet, and relays all communications.

The I/O device 336 allows the administration server to be accessed for purposes of programming, downloading data, monitoring, etc.

The user database 339 contains information about each registered user. The user database may contain multiple entries and multiple users. The user database 339 may contain information for each incentive user, such as, for example, a user name, a user I.D., a user password (password protection may be required for user access), and the number of incentives awarded. It is contemplated that other entries may be added, although it may be desirable to keep the user database 339 relatively small with regard to the number of individual fields in a record. It is a consideration that potential users not have to provide to much information when registering as members of the electronic incentive system, as this may be burdensome or otherwise off-putting to potential users. Data regarding user preferences can be accumulated by records of site visits and redemptions, as described below.

The issuer database 344 contains information pertaining to each incentive issuer (again, these issuers are typically merchants, but could be advertisers). The issuer database 344 may contain multiple entries and multiple issuers. The issuer database 344 may contain entries for each incentive issuer, such as an issuer I.D., a number of allocated incentives, an entry for incentives already issued, a date available (maturity date), and a time rule wherein the issuer may specify how frequently an incentive user can be awarded incentives.

The user info database 348 may accommodate information for a plurality of incentive users and may include additional information gathered at the time of an incentive award. It is contemplated that this database will only be updated when an incentive user redeems awarded incentives, and may be used to gather demographic data regarding the user such as name, age, gender, occupation, and any other desired demographic data.

The incentive database 352 is a table that records and tracks the generation and sale of all incentives. Entries in the preferred embodiment are organized according to each incentive issuer so that each issuer will have a separate entry in the database 352. In the preferred embodiment, the database 352 includes a record for each issued incentive, including information such as the identity of the incentive issuer, the identity of the incentive user who received it, when the incentive was awarded to the user, and the number of incentives received in the award. Through the use of the database 352, all transactions can be tracked and a total number of incentives issued and redeemed may be recorded and tracked.

The redemption database 353 may contain a description of products or services that may be redeemed. In addition, it may contain the number of electronic incentives required to redeem each product or service.

FIG. 4 shows a transaction record 400 that may be stored in the incentives administration server 107. In one embodiment, the record 400 is used to track and control electronic incentives from issuance to redemption. The record 400 may include a user ID 407, an incentive issuance date and time 412, and an incentive symbol ID 418. The user ID 407 is a unique identifier assigned to incentive users when they register as members of the incentive program with the administration server 107. The issuance date and time 412 is a time stamp created at the initial allocation of a lot of incentives to a incentive issuer, and remains unchanged for the life of the incentive. The incentive symbol ID 418 is a unique identification of each incentive symbol (“clickable” button) in the electronic incentive system 100. Because each issuer may have multiple incentive symbols on his or her site, each such incentive symbol needs an identifier so that all incentive awards may be tracked. The identification of the incentive issuer as well as, for example, the number of incentives issued, can be obtained from the incentive symbol ID 418.

FIG. 5 shows a record 500 that may be generated and stored for printed incentives which are physically shipped to issuers or printed at issuer's sites, and then, in turn, distributed by the issuer to users. Users who receive the printed incentive may then manually record the incentive (by accessing server administrator node 107) into their incentive account. Because printed incentives are generated and distributed as part of the electronic incentive system and later manually entered (e.g., by a user) into the incentive system for processing by the administrator node, the record 500 contains only partially similar data to that in record 400. As in record 400, record 500 contains a user ID 407 and an issuance date and time indicator 412. Record 500 may also contain an issuer ID 404 and an indicator of the number of incentives issued 423 (although these indicators could also be obtained from an incentive symbol ID as in record 400). Record 500 also contains an incentive serial number 519 and an incentive lot number 524. The serial number 519 and the lot number 524 are generated upon the manufacture of the printed incentives, and allow verification of authenticity before an incentive is accepted and credited to an incentive user. The printed incentives can thus be distributed through conventional channels, yet converted to electronic incentives for storage and redemption.

When a user records their awarded incentive into their account, they do so by entering the incentive serial number (printed on the incentive) into their incentive account. In a preferred embodiment, the serial number is concealed on the printed incentives, and the user must scratch off a protective coating or lift a flap in order to view the serial number. The printed incentives may be manufactured in various values for convenience. Tampering or fraud may be discouraged by using serial numbers with enough digits so that only a small number of possible serial numbers are ever used. This scheme ensures that a counterfeit incentive may be easily detected. In the preferred embodiment, the incentives employ a 12 character serial number. By employing 26 lowercase letters and the numbers 0 through 9, a possible 4.738381338322e+18 (4,738,381,338,322,000,000) combinations may be generated. Planning for uniqueness of each number in an average block of a 1,000,000,000 possible IDs, 4,738,381,338 electronic incentives can be safely randomized. That means that many printed incentives can be issued while still ensuring that someone trying to guess a valid serial number would have only a one in one billion chance on a single try.

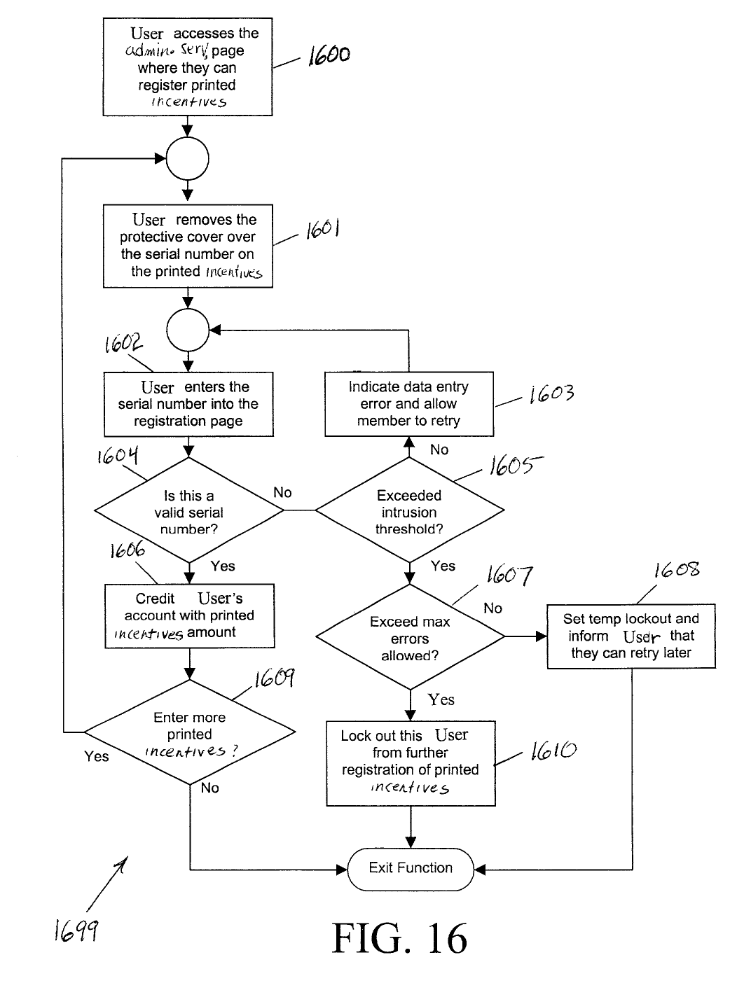

In an alternative embodiment for a printed incentive, the record 500 contains the site address of an incentive issuer. As described below in connection with the discussion of FIG. 16, an incentive user may convert such a printed incentive to an electronic incentive by visiting the issuer's site 101 and selecting (clicking on) a modified incentive symbol at the site (rather than by accessing the administration server node 107). Such a printed incentive would further motivate incentive users to visit issuer sites.

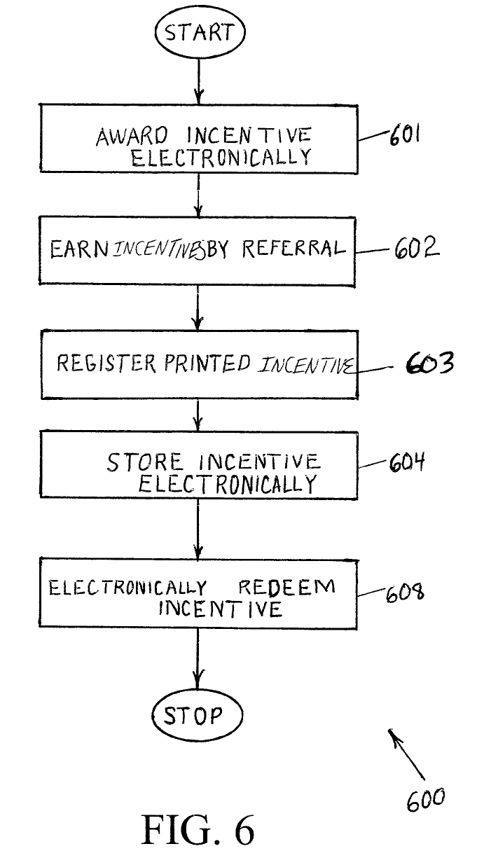

FIG. 6 shows a flowchart 600 of a first embodiment of the present invention. In Step 601, an electronic incentive is electronically awarded to a consumer/incentive user. The award is in response to the selection of an electronic incentive symbol (i.e., “clicking on” the symbol) at a network site 101 of a participating issuer (merchant or advertiser) and/or for purchasing goods or services from an issuer. That is, the user can be awarded electronic incentives for clicking on the incentive symbol, as those symbols appear at various portions of an issuer's Web site during surfing of that Web site, and/or for actually purchasing goods or services.

In the preferred embodiment, an incentive logo design may be displayed as part of an on-line advertisement, such as a banner ad, advertising an issuer's site. This display is to entice the user to click on the advertisement to visit the site mentioned in the advertisement and does not, itself, effect the award of stamps. Rather, the logo design lets the user know that he or she will find incentive symbols, which do award incentives, at the site to be visited. Once at the issuer's site, users locate incentive symbols throughout the site and are awarded incentives for clicking on the symbols. Each incentive symbol on an issuer's site can have its own rules with regard to how many incentives are issued and how often. This encourages the incentive user to extensively browse the issuer's site, spending more time at the site than that typically spent pursuant to current incentive programs.

In an additional embodiment, the incentive awarding Step 601 also includes electronically displaying a pop-up type advertisement upon the user's being awarded their selected incentives. The pop-up type advertisement may be a pop-up window containing a message regarding advertiser or merchant products or may be a banner-type advertisement. The invention thus enables additional and varied advertising opportunities.

The issuer site 101 (FIG. 1) is preferably a Web site on the Internet, but alternatively may be a site on a local area network (LAN), wide area network (WAN), electronic bulletin board service (BBS) or any other electronic computer network. The amount of the incentive award may be governed by a predetermined rule, so that the electronic incentive award may be automated and granted electronically. It is contemplated that the participating merchant site 101 will be a computer capable of being accessed over a network, such as the Internet, for example. Potential incentive users may access the merchant site via their own computers (node 104) linked to the network 103.

In Step 602, which is an optional step in the process, incentives may be earned by a current user by referral of a non-user. A incentive user displays an electronic incentives membership symbol 116 (FIG. 1) on his or her site, and if a non-incentive user clicks on the membership symbol 116, the user may receive an award of a predetermined amount of incentives. In this manner, current users are encouraged to recruit additional users.

In Step 603, which is also an option in the process, printed incentives, for example, those received by a user from a merchant who has shipped selected product, may be electronically registered and converted into electronic incentives for future use by the incentive user. The conversion of printed incentives to electronic incentives is discussed below in the text accompanying FIG. 16.

In Step 604, the incentive is electronically stored in an account database attached to the network 103. Therefore, a incentive user can access his or her incentive account to view the contents, add more incentives, or redeem any accumulated incentives. In the preferred embodiment, the database is a central database containing information concerning all user accounts and information regarding all participating incentive issuers. In a alternative embodiment, incentives may be stored at the issuer's site.

In Step 608, the user electronically redeems the awarded incentives by requesting redemption. In the preferred embodiment, a user 104 (FIG. 1) interacts with the administration server 107 to place a redemption order. Server 107 then communicates the order to redemption product vendor server 102 which then forwards products or services directly to the user. (Alternatively the redemption may be performed by the administration server 107, acting as a broker for products or services.) The number of incentives required for a particular redemption is established by and displayed to the user by the administration server 107. Redemption product vendor server 102 may feature goods and services of all issuers. The redemption may take the form of free goods or services, price discounts, favorable treatment in purchasing of goods or services, extended warranties, or any other benefit desired to be awarded by the participating issuer. The redemption product vendor server 102 may purchase goods and services from participating issuers, and may arrange to purchase the same at a price below a retail price.

In an alternate embodiment of Step 608, the administration server 107 may offer goods and services for redemption. In another alternate embodiment, issuers 101 may themselves redeem electronic incentives from the users.

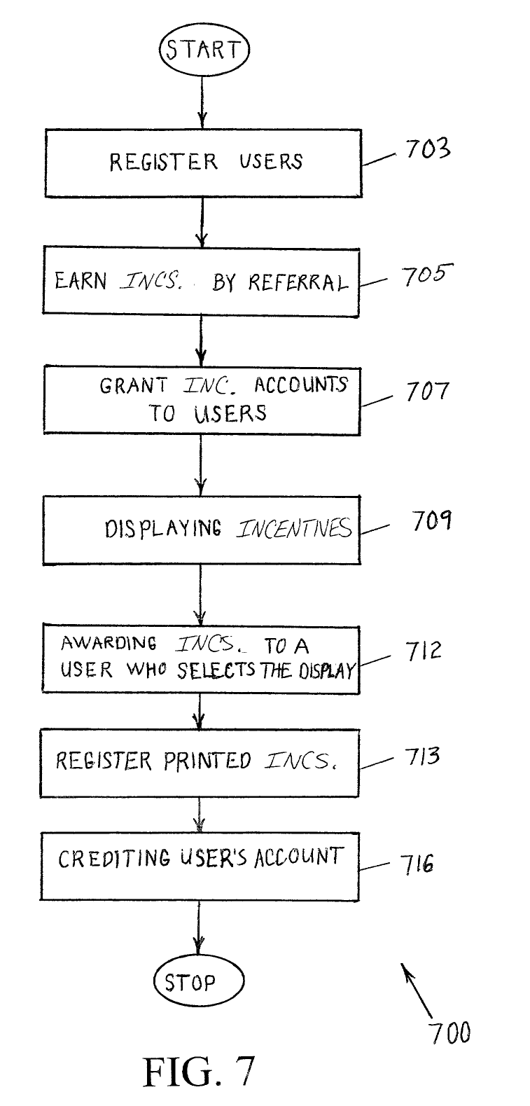

FIG. 7 shows a flowchart 700 of a second embodiment of the present invention. In Step 703, users are electronically registered in a users database in the administration server 107 (FIG. 1). This step may be performed over a network. In the preferred embodiment, to participate in the incentive system, all users must be registered (must be members). The registration step ensures that records are available for incentive awards and redemptions.

In optional Step 705, incentives may be earned by referral. A user may display an electronic membership symbol 116 on his or her site, and if a non-incentive user clicks on the membership symbol 116 and completes the membership process, the user may receive an incentive award of a predetermined amount of incentives. In this manner, current member users are encouraged to recruit new member users.

In Step 707, a registered user is granted an incentive account, preferably in the administration server 107. In the preferred embodiment, the centralization of all records in the administration server 107 ensures that records are dutifully kept and lessens the likelihood of tampering or fraud.

In Step 709, an incentive symbol is displayed at all issuer sites. The symbol notifies all site visitors that a particular network site is indeed an electronic incentive issuer, and that a registered user may be able to pick up an electronic incentive award from the site. Preferably, each site will continuously display the incentive symbol.

In Step 712, the incentive administration server 107 awards a predetermined amount of incentives to a user who selects (or “clicks on”) the incentive symbol. As discussed earlier, the user can be awarded electronic incentives for clicking on the symbols encountered while surfing various portions of an issuer's Web site, and for purchasing the goods or services. The predetermined award amount may be set by a rule in the issuer's site, or may be set by a rule in the issuer's account. The award amount is preferably set when incentives are purchased by the issuer, and is preferably stored in the administration server 107. The award amount is the number of incentives awarded to users who visit the issuer's site and click on the symbol or who purchase goods or services. In this manner, site visitors or “surfers” are rewarded for visiting the sites of participating incentive issuers and/or for purchasing goods or services. As an additional benefit, information may be gathered from, for example, the frequency and nature of particular incentive awards and used to evaluate the effectiveness of various incentive symbol placement and presentation strategies, issuer Web site design or advertising, etc.

In optional Step 713, printed incentives may be electronically registered and converted into electronic incentives for future use by the user. The conversion of printed incentives to electronic incentive of the system 100 is discussed in the text accompanying FIG. 16.

In Step 716, after the user has clicked on the incentive symbol, the predetermined number of incentives are credited to the user's account. The issuer's site includes a programmed link from the issuer's Internet address to an address of the incentives administration server 107. Coupled with the link is an electronic identification that is transmitted to the administration server 107 and identifies the particular incentive issuer. This electronic identification may be verified against an identification stored in the administration server 107. Activation of the link by a user via the computer network initiates an incentive issuance software program that not only identifies the issuer but also identifies the user. The issuance software then confirms whether the user is eligible to receive the award, and if eligible credits the user's account and debits the account of the issuer. The issuer is then notified of the successful award, and the transaction is recorded in the administration server 107.

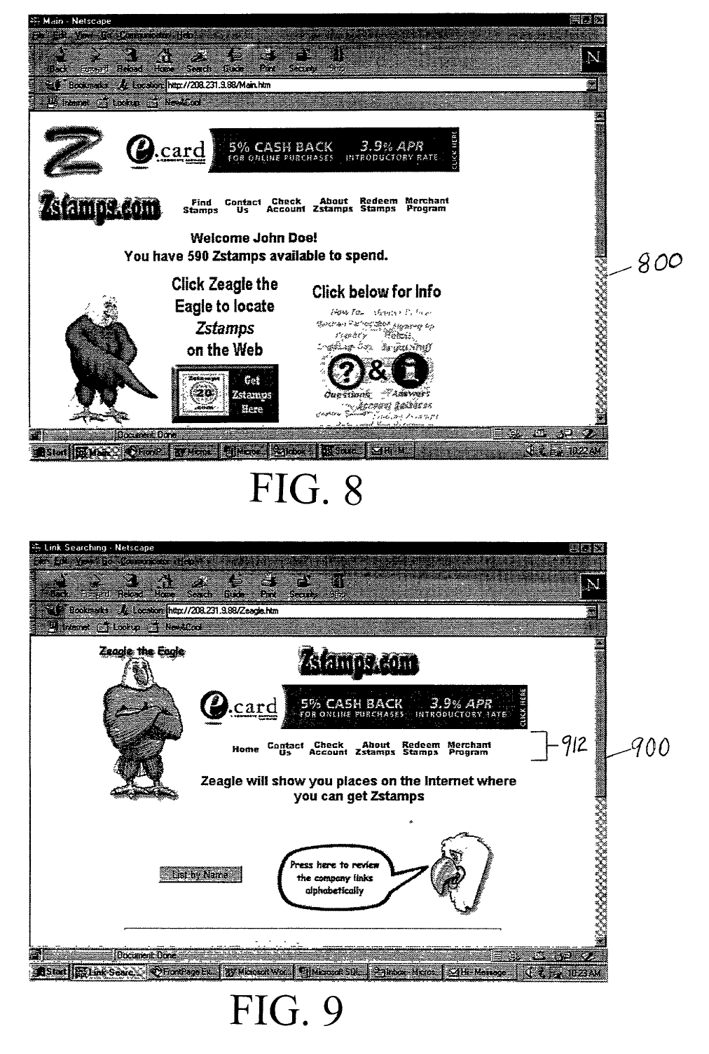

FIG. 8 shows a screenshot 800 of a main menu screen which is displayed by the administration server 107 to a user's computer screen upon initial access to the server 107 by the user. The main menu screen 800 may include selections such as clicking to locate issuer's sites having incentive symbols, checking user account status, redeeming incentives, and responses to common questions and other information about the incentive system capabilities and features.

FIG. 9 shows a second such screenshot displaying buttons which can be selected by the user in order to search for sites of issuers awarding incentives, specific issuers, or for specific goods or services offered by issuers.

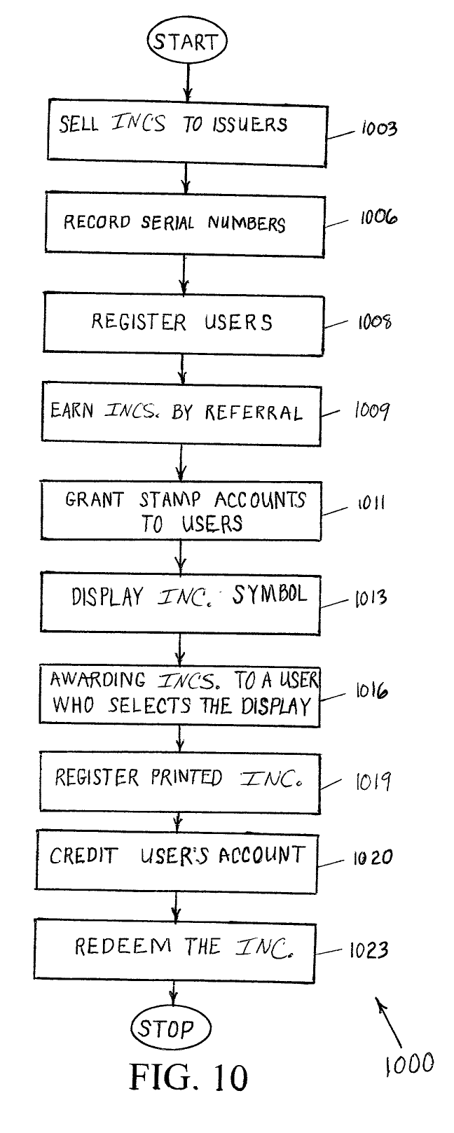

FIG. 10 shows a flowchart 1000 of a third embodiment of the present invention. In Step 1003, incentives are electronically sold, e.g., by the administrator operator, to the various issuers. The incentives sold may be recorded in both an issuer database 114 (FIG. 1) (or 344, FIG. 3) and an incentive database 352, FIG. 3 in the administration server.

In Step 1006 the serial numbers of the issued incentives are recorded in the administration server 107. In a preferred embodiment (for electronic incentives), incentives are issued and sold in lots, and individual incentives are not tracked. Instead, after issuance, the system tracks the particular button (incentive symbol) from which the incentives were issued (and, therefore, also tracks via a database link, the issuer on whose site the symbol was placed), along with the user ID and the date and time of incentive issuance. In an alternative embodiment, the serial number of each incentive may be tracked from purchase by an issuer, through award to a user, and to redemption for goods or services.

In Step 1008, users are electronically registered in a users database 113. This step is performed over the network 103. In the preferred embodiment, to participate in the incentive system, all users must be registered. The registration step ensures that records are available for incentive awards and redemptions.

In optional Step 1009, incentives may be earned by referral. A user may display an electronic incentive membership symbol 116 on his or her site, and if a non-incentive user clicks on the membership symbol 116, the user may receive an award of a predetermined amount of incentives. In this manner, current member users are encouraged to recruit new member users.

In Step 1011, a registered incentive user is granted an incentive account in the administration server 107. The account is used to accumulate all incentives awarded to the particular user.

In Step 1013, an incentive symbol is displayed at all participating issuer sites. The symbol notifies all site visitors that a particular site is indeed an electronic incentive issuer, and that a user may be able to pick up an electronic incentive award from the site. Preferably, each issuer site will continuously display the incentive symbol.

In Step 1016, a predetermined amount of incentives are granted to a user who selects (“clicks” on) an incentive symbol. The user can be awarded electronic incentives for clicking on symbols that appear while surfing the issuer's Web site, and for purchasing goods or services. The predetermined amount may be governed by a rule in the issuer's site. This number is preferably set when incentives are purchased by the issuer, and is preferably stored in the administration server 107.

In optional Step 1019, printed incentives may be electronically registered and converted into electronic incentives for future use by the user. The conversion of printed incentives to electronic ones is discussed in the text accompanying FIG. 16.

In Step 1020, after the user has clicked on the incentive symbol, the predetermined number of incentives are issued and credited to the user's account. In the preferred embodiment, the administration server 107 adds the number of incentives issued to a field that tracks the total amount of incentives issued by a particular issuer. When this field is compared with the total amount of incentives originally allocated to the issuer, one arrives at the new incentive amount available to be issued. Correspondingly, the user's account is credited with the number of incentives issued.

In Step 1023, a user who has accumulated electronic incentives can redeem same for valuable goods, services, etc. In the preferred embodiment, the incentives are redeemed by the redemption product vendor server 102, via the user's selection of goods and services presented on the administration server 107 (the server 107 then communicates same to vendor server 102). Alternatively, in another embodiment, either the administration server 107 or the individual issuers may have the capability to redeem and display items to be redeemed.

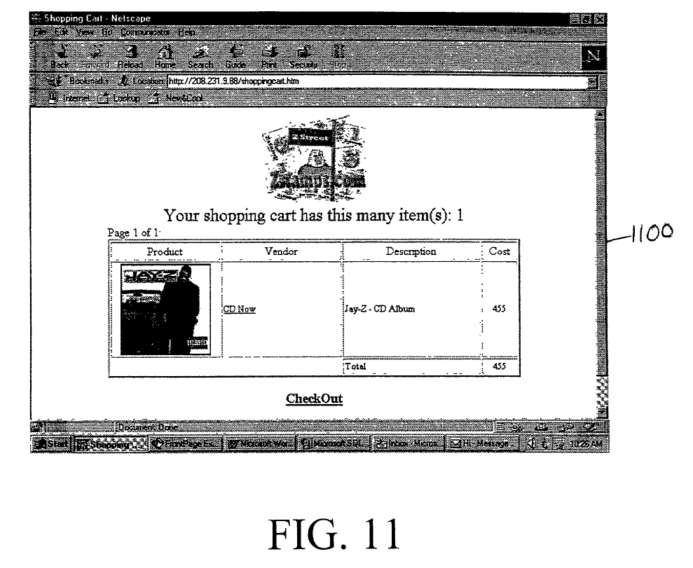

Also in step 1023, any item selected to be redeemed through the use of electronic incentives may be placed in an electronic shopping cart which may be used to accumulate items to be purchased or redeemed. This is shown in the screenshot 1100 of FIG. 11. The electronic shopping cart generally displays information about selections, and displays individual selections that the user has selected. For example, the shopping cart 1100 may display a product title, a product description, and may display a redemption price in electronic incentives. In addition, multiple items chosen for redemption may be displayed and the shopping cart 1100 may display a cumulative total. The user may thereby decide what combination of items to redeem in order to make optimum use of any accumulated incentives.

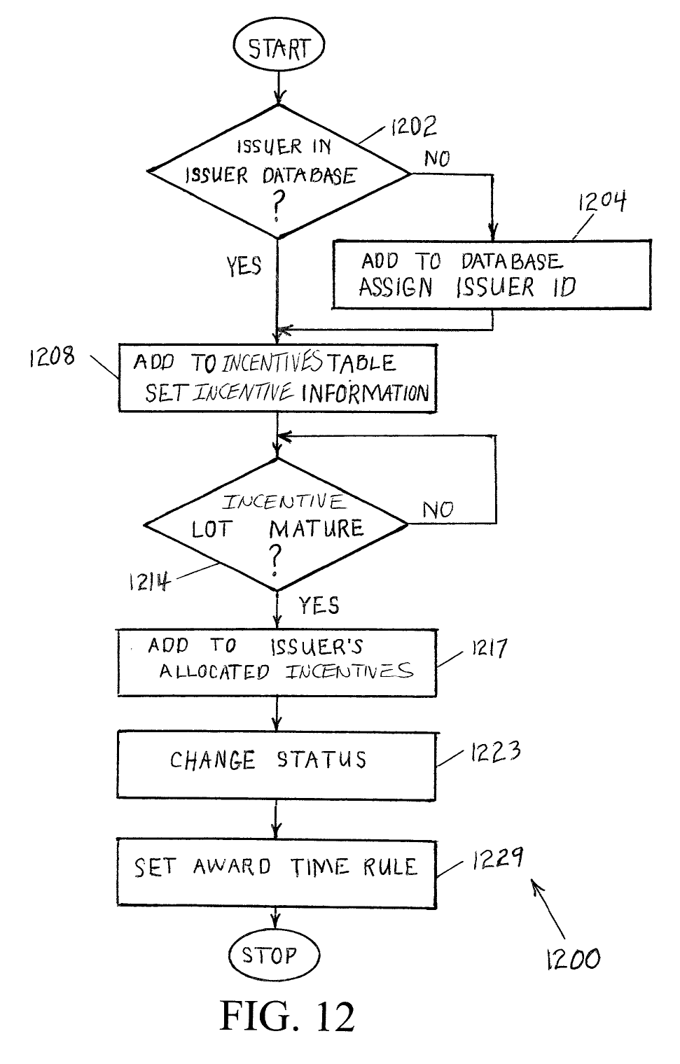

FIG. 12 shows a flowchart 1200 of the purchase of electronic incentives by an issuer such as a merchant. In Step 1202, the process checks to see whether the issuer is currently in the issuer database 114 in the administration server 107. If the issuer currently is registered in the issuer database 114, the method proceeds to Step 1208, otherwise it branches to Step 1204. In Step 1204, the prospective issuer may be registered as an electronic incentive issuer. This may include adding the issuer to the incentive issuer database 114 and assigning an issuer I.D. and recording other pertinent information described above.

In Step 1208, a requested quantity of incentive is added to an incentives table within the administration server 107. In addition, other details such as maturity date of the electronic incentives (i.e., when they become effective), an allotment size, and a status are also added. The status of purchased or allocated incentives will be recorded as pending until the maturity date, at which time they may be transferred to an active status.

In Step 1214, the administration server 107 monitors to see when the incentive lot becomes mature. If the maturity date has not been reached, Step 1214 repeats until the maturity date has been reached for the particular lot. When the maturity date has been reached, the method proceeds on to Step 1217.

In Step 1217, the mature quantity of incentives are added to the incentive issuer's allocated incentives. For a new issuer, the allocated incentive number will be zero. However, for previously registered issuers, there may be a remaining number of unused and unawarded incentives, and any new incentive purchase will be added to that number. In Step 1223, the status of the purchased incentives is changed in the incentive payable from a pending status to an issued status.

In Step 1229, a time period between allowed awards is set in the issuer database 114. The time period in the preferred embodiment will be set by the issuer. The time period is a rule that prevents a user from getting an award of incentives more often than a certain frequency. For example, a rule may say that each user may only get one award of incentives per week for clicking on the incentive symbol. So when an user is surfing through the incentive issuer's site, the issuer may award incentives for just surfing. However, issuers won't want to allow a user continuous access and the possibility of ringing up an unreasonably large total of incentives. This, of course, may not apply to actual purchase of items, for which incentives may always be awarded.

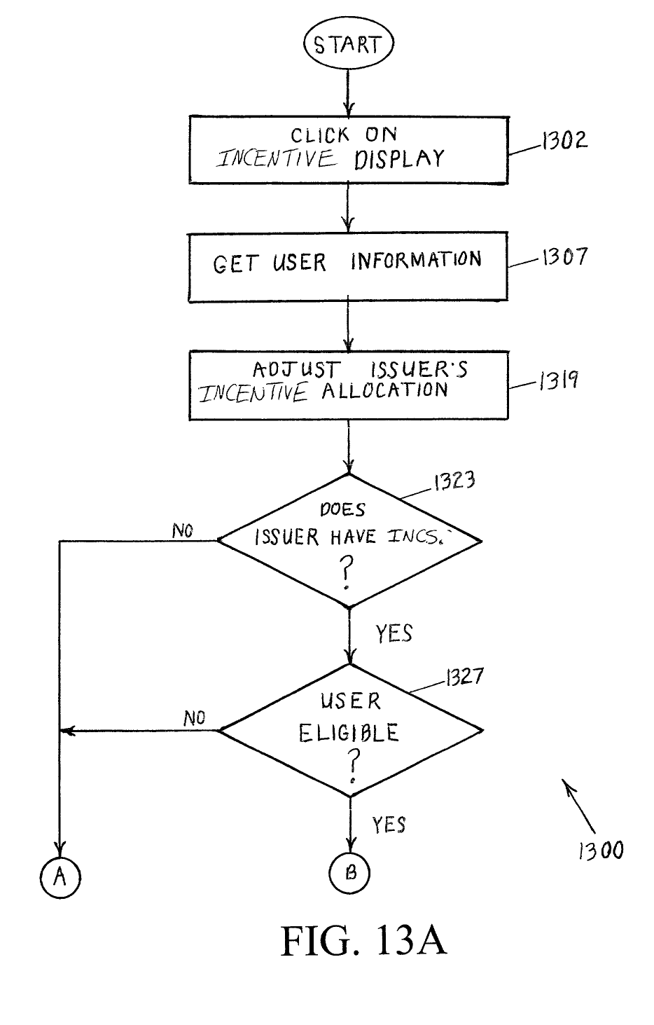

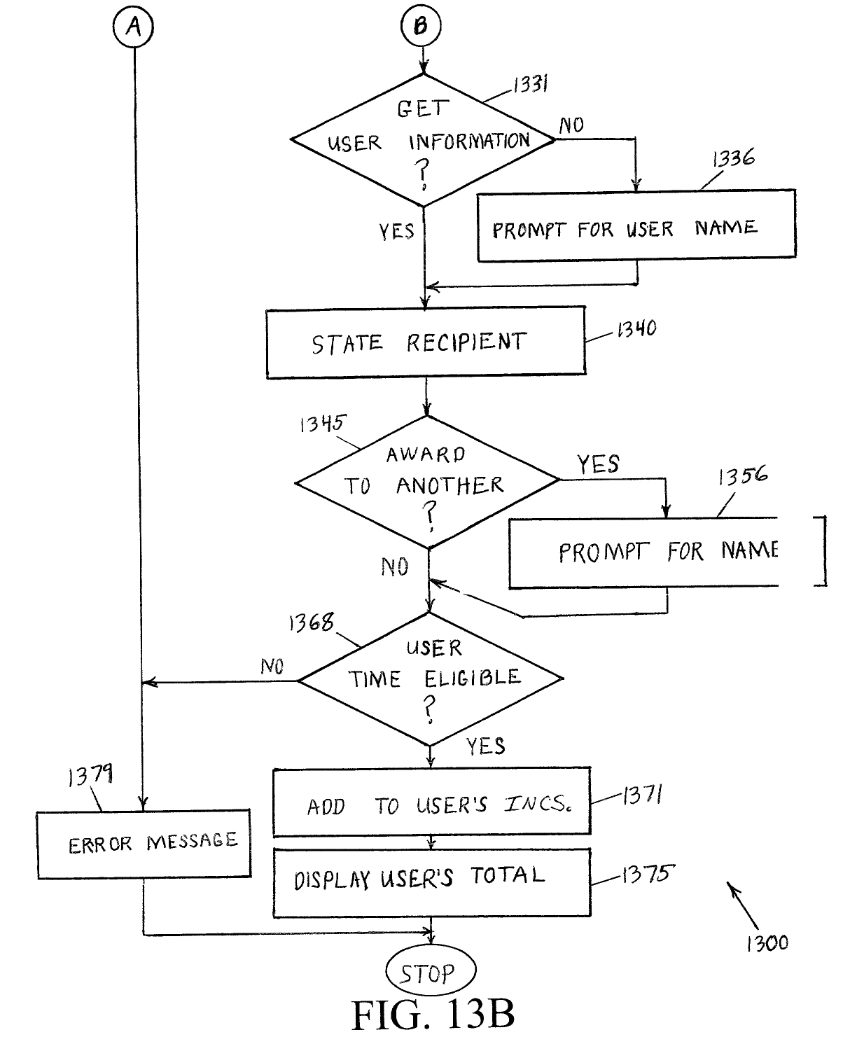

FIGS. 13A and 13B show a flowchart 1300 of the method of electronically awarding incentives to a member user. In Step 1302, a user clicks on the incentive issuer's electronic incentive symbol in order to get an award of electronic incentives. Again, generally, the user can be awarded electronic incentives for clicking on the incentive symbol while surfing the issuer's Web site or for purchasing issuer goods or service.

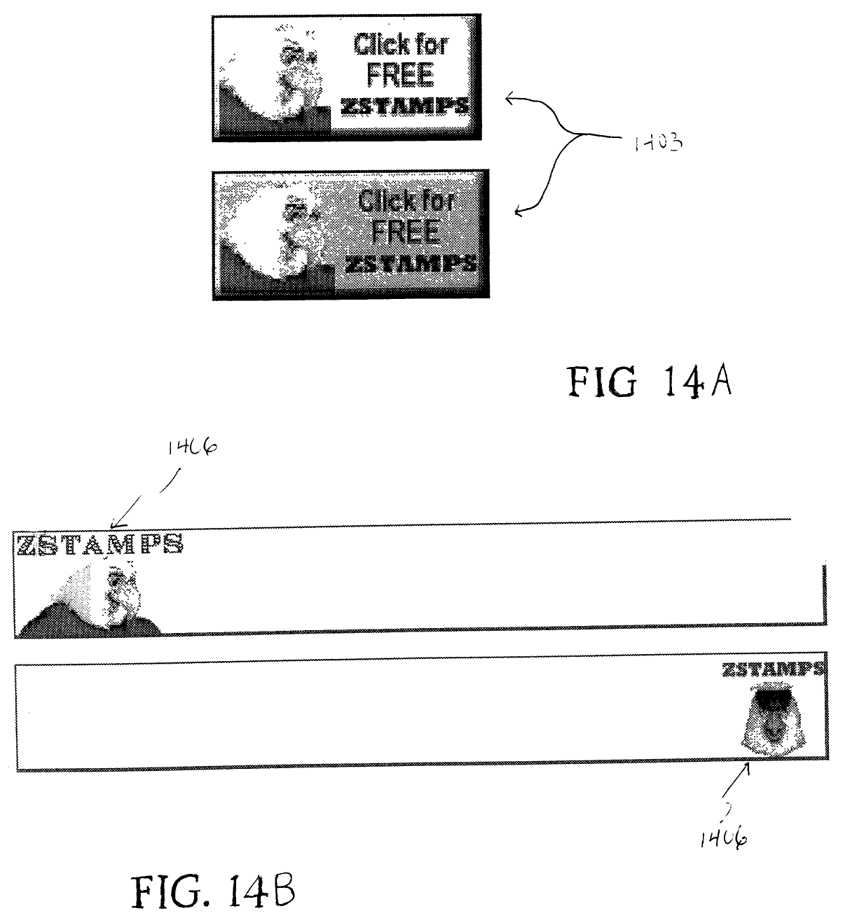

FIG. 14A shows representative incentive symbols 1403 that would be displayed at various locations on an incentive issuer's Web site 101. Users click on the symbol 1403 while performing actions on the issuer's site, and thereby receive incentives. In the preferred embodiment, the incentive symbol is in a Joint Photographic Expert Group (JPEG) format, but alternatively other formats may be used, and various types of data compression may be employed. FIG. 14B shows representative incentive logo designs 1406 placed within a banner-type advertisement to let user's know that they will find incentive symbols (and thus incentive awards) on the issuer site referenced in the ad. Again, in the preferred embodiment, awards are not given by a user's simply clicking on the banner ad, but rather, only when once arriving at the site, the user browses the site locating incentive symbols 1403 and clicking on them. (Of course, in alternative embodiments, an incentive user could receive an award by clicking on an incentive symbol embedded in a banner ad, but that is less preferred.)

In Step 1307, certain incentive user information may be obtained by the administration server 107 after the user clicks on the electronic incentive symbol 1403. Such user information may include user name or I.D., and survey-type user feedback from issuer's sites. Other user information collected for demographic purposes, such as age, gender, occupation, preferences in terms of purchases from the particular incentive issuer, etc. is typically collected during the initial user membership sign-up process.

In Step 1319, the administration server subtracts the awarded incentives from the issuer's incentive allocation.

In Step 1323, it is determined whether the issuer has enough allocated incentives to award. If the issuer does not have enough incentives to award, the method branches to Step 1379, else it proceeds on to Step 1327 and the transaction continues.

In Step 1327, the process checks to see whether the user is eligible to receive the incentive award. For example, this step in the preferred embodiment checks to see whether the incentive user is registered and may not proceed with the transaction if the user is not registered. Alternatively, in a lesser preferred embodiment, the user's status may not matter, and the award may still proceed. If the user is not eligible, the process branches to Step 1379, otherwise it proceeds to Step 1331.

In Step 1331, the process checks to see whether incentive user information is available. In the preferred embodiment, this is a check to see whether a user cookie has been procured from the user's browser. In a typical Internet browser, any visited Web site may store information on the user's browser to be employed subsequently for purposes of bringing up pertinent information. This is referred to as a “cookie.” If a user cookie is not available, the process branches to Step 1336, else it proceeds ahead to Step 1340.

In Step 1336, the user is prompted for his or her name. In the preferred embodiment, this is the name (or handle) that a user provides during the membership sign-up process. This step may also include a provision for capturing incentive award information for non-members. For example, if a non-member clicks on an incentive symbol, he or she could be prompted to enter contact information, such as an e-mail address, so that instructions regarding membership may be forwarded to them; awards of incentives would be finalized upon their completing the membership process.

In Step 1340, the process displays to the incentive user the user's name as being the recipient of the incentive award.

In optional Step 1345, the process would prompt the user for an optional name for the incentives to be awarded to. For example, in one embodiment, the user may donate his or her electronic incentive award to another user, such as a family member or a friend. If the user desires to give the award to another, the process branches to Step 1356, else it proceeds to Step 1368. In optional Step 1356 (assuming Step 1345 is performed), the user is prompted for a recipient name of the person he or she wishes to give the incentive award to. In the preferred embodiment, the recipient must be another registered user, but alternatively the recipient may be anyone. It is noted that if the processes of Steps 1345 et seq. are performed, suitable precautions must be in place to prohibit fraudulent use of incentives.

In Step 1368, the administration server 107 determines whether the user is time eligible to receive an incentive award. Because a time rule may be given by each issuer to prevent frequent and repeated awards by users, the electronic incentive system 100 must verify that the particular user is time eligible. For example, the issuer may designate that surfing awards will only be given out once per week for all incentive users. Therefore, if a user returns to the same site in less than a week and clicks on the incentive symbol that gives electronic incentives just for surfing the site, the award will be denied until at least a week has lapsed. If the member is not time eligible, the process will branch to Step 1379, otherwise, it will proceed to Step 1371.

In Step 1371, the value of the awarded incentives will be added to the appropriate entry in the user database 113 in the administration server 107. Each registered user will have their own entry and each user will therefore have their own awarded incentive total, and the awarded incentives will therefore be added cumulatively.

In Step 1375, the administration server 107 may display to the user the current incentive total after the incentive award.

In Step 1379, an error message may be displayed signifying that the award transaction cannot or will not be completed. For example, the display may read “Please try again later” or other suitable message.

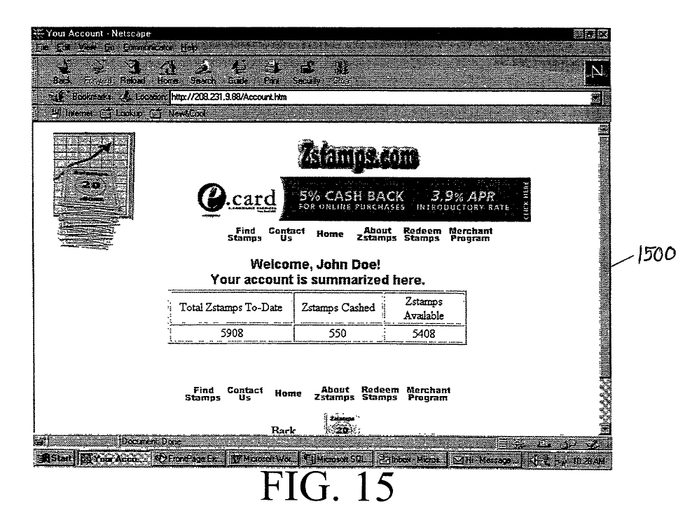

FIG. 15 shows a screenshot 1500 displayed on a member computer of such an award statement showing total incentives accumulated, total incentives that have been redeemed, and an amount currently available to be redeemed. In addition, other information may be presented on the screen, such as a breakdown of individual awards, sources of awards, dates of awards, and other relevant information.

FIG. 16 shows a flowchart 1699 of a method for converting a printed incentive (such as that received by a consumer from a product provider with a shipped product) into an electronic incentive of the electronic incentive system 100.

In Step 1600, a user accesses the administration server 107. This may be done over the Internet. The administration server 107 preferably includes a printed incentive registration page.

In Step 1601, the user uncovers a serial number printed on the incentive. It should be understood that this step may occur at any time previous to the actual entry of the serial number into the electronic system 100.

In Step 1602, the user enters the serial number into the incentive registration page.

In Step 1604, the serial number is checked for authenticity. This may be done by comparing the printed incentive serial number to all issued serial numbers (see text accompanying FIG. 5). Specifically, each printed incentive will be recorded in a database in administrator node 107 prior to sale to an issuer (who will subsequently dispense the incentives). When an user, who has received the incentive, records the incentive serial number, the system will look the serial number up in the database. If the serial number does not exist, it will be logged as an error. If the serial number does exist, the system will make certain that the serial number has not already been claimed. If the serial number has not been claimed, then it will be marked as claimed in the current transaction. If the serial number is authentic, the method proceeds to Step 1606, else it branches to Step 1605.

In Step 1605, it is determined whether an intrusion threshold has been exceeded. Specifically, to prevent a wayward user from attempting to manually guess serial numbers, or more importantly to prevent a hacker who attempts the same guessing process using a computer program, the incentive system 100 will track two totals of wrong entries. One tallies the grand total of all wrong entries. The second total tracks the number of most recent, consecutive wrong entries. For an individual wrong answer that does not break the predetermined threshold of consecutive wrong answers, the system will add to the totals, inform the user as in Step 1603, and allow a retry. If the threshold is reached, the system determines if this wrong answer has reached a second threshold of total wrong answers over the lifetime of the membership, using the first number described above to make this determination. If not, then the system applies a lockout for a predetermined period of time, during which time the user cannot make new entries. If the second threshold is reached, the user will be permanently barred from participating in this part of the program. Also, suitable thresholds will be set to allow for legitimate entry of wrong numbers. If the intrusion threshold described above has not been exceeded, the method branches to step 1603, where an entry error message is transmitted to the user and the user is allowed to re-enter the serial number back at Step 1602. If the intrusion threshold was exceeded, the method branches to Step 1607.

In Step 1606, the user's account is credited with the printed incentive amount.

In Step 1607, if the maximum allowable errors has been exceeded, the method proceeds to Step 1610, else it branches to Step 1608.

In Step 1608, a temporary lockout is activated. The lockout prevents the user from accessing the incentive registration page for a predetermined period of time. In addition, the user is informed that he or she can retry the printed incentive registration process at a later time.

In Step 1609, the user is prompted concerning whether more printed incentives are to be registered. If yes, the method branches back to the incentive entry of Step 1601.

In Step 1610, because the maximum number of errors has been exceeded, the user is locked out from further registration of printed incentives.

In an alternate method for converting a printed incentive into an electronic incentive, the printed incentive contains the site address of an incentive issuer. (This type of printed incentive could be an alternative to or an option in addition to the printed incentives described above.) The issuer site contains at least one modified electronic incentive symbol which may be accessed by the user's clicking on the symbol and used to enter the printed incentives into the user's electronic incentive account. Specifically, upon a user's accessing the issuer's site and selecting the modified electronic incentive symbol, a pop-up window appears on the issuer's site to dialog with the user. The user enters his or her user ID and the serial number of the printed incentive. Upon proper validation similar to that described in connection with FIG. 16, the incentives are accrued in the user's account residing on the administration node.

In further embodiment of the invention, two types of incentives are issued to users. The first type of incentive (type 1) is that as described above, namely, an incentive that is redeemable for products and services. The second type of incentive (type 2) is different from a type 1 incentive in that it cannot be immediately redeemed for products and services. Instead, type 2 incentives may be exchanged for type 1 incentives when a purchase is made from an issuer. The type 2 incentives are typically rewarded for a user's non-purchasing activities, and when a user does make a purchase, the type 2 incentives may be used to match the redeemable type 1 incentives that are offered with the purchase. For example, a user may purchase an item for which 50 type 1 incentives are offered as a reward for doing so. If the user has a collection of type 2 incentives available at the time of this purchase, he/she will be able to convert up to 50 of the type 2 incentives to type 1 incentives, resulting in a total amount of 100 incentives available for redemption. Type 2 incentives increase a user's propensity to purchase products because as the user's available amount of type 2 incentives grows, these incentives represent an increasing value of purchases that have type 1 incentives associated with the purchases. Further, type 2 incentives, awarded essentially for free, are particularly protected from fraud as they are not immediately redeemable for products or services, but rather are used to match the type 1 incentives offered for a particular purchase.

While the invention has been described in detail above, the invention is not intended to be limited to the specific embodiments as described. It is evident that those skilled in the art may make numerous uses and modifications of and departures from the specific embodiments described herein without departing from the inventive concepts.

What is claimed is:

1. An electronic on-line advertisement enhancement and incentive system which offers an incentive to an incentive user of an electronic computer network, said system comprising:
an incentive administration server, comprising:
1) an input/output device;
2) an electronic computer network interface connected to said electronic computer network;
3) an incentive issuer database;
4) an incentive user database;
5) an incentives database; and
6) a processor connected to said input/output device, said electronic computer network interface, said incentive issuer database, said incentive user database, and said incentives database and operative to control an issuance, award, storage, and redemption of said incentives over said electronic computer network; and
at least one incentive issuer node, comprising an electronic stamps symbol to be displayed to users accessing said at least one incentive issuer node, said electronic incentive symbol representing said at least one incentive issuer node's participation in said electronic on-line system.

2. The system of claim 1, wherein said electronic computer network is the Internet.

3. The system of claim 1, wherein said incentive user database contains information on each incentive user.

4. The system of claim 1, wherein a potential incentive user requests registration in said incentive user database.

5. The system of claim 1, wherein said incentives database contains information on all incentives sold to issuers.

6. The system of claim 1, wherein said incentive issuer database contains information on all incentive issuers subscribing to said electronic on-line system.

7. The system of claim 1, wherein when said incentives are purchased by an incentive issuer, said purchased incentives are recorded in said incentive database in said incentives administration server and in said incentive issuer database.

8. The system of claim 1, wherein an incentive user is awarded at least one incentive when accessing said at least one incentive issuer node.

9. The system of claim 1, wherein an awarded incentive is recorded and stored in said incentive user's entry in said incentive users database.

10. The system of claim 1, wherein said incentives administration server further includes an incentive users information database which stores demographic information obtained from said incentive user.

11. The system of claim 1, wherein said electronic incentive symbol is displayed on said at least one incentive issuer node.

12. The system of claim 1, wherein said electronic incentive symbol is associated with an online advertisement on said computer network.

13. The system of claim 11, wherein a logo representation of said incentive is also displayed in association with an on-line advertisement on said computer network, said logo representation for directing said incentive user to said incentives issuer node.

14. The system of claim 1, wherein a membership symbol is displayed on an incentive user node, wherein selection of said membership symbol by a non-incentive user awards a predetermined amount of incentives to said incentive user.

15. An electronic incentive for use on an electronic computer network, comprising:
1) an electronically stored incentive user identifier;
2) an electronically stored incentive issuance date and time; and
3) an electronically stored incentive symbol identifier.

16. The electronic incentive of claim 15, also comprising an electronically stored incentive issuer identifier;

17. The electronic incentive of claim 15 wherein said incentive symbol identifier also contains information identifying an incentive issuer.

18. A printed incentive for use with an electronic computer network, said printed incentive capable of being converted into an electronic incentive, comprising:
1) an electronically stored incentive user identifier;
2) an electronically stored incentive issuance date and time;
3) an incentive serial number printed on said incentive; and
4) an incentive lot number printed on said incentive.

19. The printed incentive of claim 18, which also comprises an electronically stored incentive issuer identifier.

20. The printed incentive of claim 18, wherein said serial number is initially concealed on said incentive.

21. The printed incentive of claim 18, wherein said serial number comprises a combination of numeric digits and letters.

22. An electronic advertisement enhancement and incentive method which offers an incentive to an incentive user over an electronic computer network comprising the steps of:
electronically awarding an incentive to said incentive user over said electronic computer network, said incentive being in the form of a predetermined amount of electronic incentives awarded by an incentive issuer;
electronically storing over said network said incentive in an incentive administration server, and accessible over said electronic computer network; and
electronically redeeming over said network said incentive at said incentive user's discretion.

23. The method of claim 22, wherein said redeeming is performed over said network by said incentive administration server.

24. The method of claim 22, wherein said redeeming is performed over said network by said incentive issuer.

25. The method of claim 22, further including the step of registering an incentive user and gathering incentive user information.

26. The method of claim 22, wherein said step of awarding incentives includes awarding a predetermined value of said electronic incentives to an incentive user who visits the site of the incentive issuer on said computer network.

27. The method of claim 22, wherein said step of awarding incentives includes awarding a predetermined value of electronic incentives to an incentive user who purchases an item from the incentive issuer.

28. The method of claim 22, wherein said step of awarding a predetermined value of electronic incentives further includes recording information concerning said incentive user.

29. The method of claim 28, wherein said information includes information indicating purchasing and viewing habits of said incentive user.

30. The method of claim 22, wherein an incentive issuer sets said predetermined value of said electronic incentives to be awarded during said awarding step.

31. The method of claim 22, further including the steps of:
selling said electronic incentives to an incentive issuer; and
recording in an electronic incentive database serial numbers of said electronic incentives sold.

32. The method of claim 22, further including the step of electronically displaying over said network at least one electronic incentive symbol at a site of an incentive issuer.

33. The method of claim 22, further including the step of electronically crediting over said network an electronic incentive user account of said incentive user.

34. The method of claim 22, wherein the awarding step comprises awarding a printed incentive which may be electronically registered to convert said printed incentive to said electronic incentive.

35. The method of claim 22, wherein said awarding step comprises the steps of:
displaying a membership symbol on a site of said incentive user; and
electronically awarding said incentive to said incentive user when a non-incentive user selects said membership symbol to access said incentives administration server and completes a membership process with said incentive administration server.

36. The method of claim 22, further including the steps of displaying an incentive logo design in association with an advertisement on said computer network and permitting said incentive user to visit said incentive issue's site by accessing said advertisement.

37. The method of claim 36 further including said awarding step wherein said incentive user is awarded said incentive when said user visits the incentive issuer site and accesses an electronic incentive symbol displayed on said site.

38. The method of claim 22, wherein the awarding step further includes displaying, to the incentive user, simultaneously upon the awarding of said incentives, said window containing an advertisement.

39. The method of claim 22, wherein said incentive is of a first type that is not directly redeemable for products or services, but may be redeemed for a second type incentive that is directly redeemable for products or services.

40. An electronic incentive method which offers an incentive to a user over an electronic computer network, comprising the steps of:
electronically registering over said network an incentive user and granting said incentive user an incentive account in an incentives administration server;
electronically displaying over said network said incentives at a site of an incentive issuer;
electronically awarding over said network a predetermined value of incentives to said user upon access of said site of said incentive issuer and upon selection of a displayed electronic incentive symbol; and
electronically crediting over said network an incentive user's incentive account in said incentives administration server;
wherein said registered incentive user may accumulate and redeem said incentives.

41. The method of claim 40, wherein the step of registering said incentive user includes gathering incentive user information.

42. The method of claim 41, wherein said incentive user information contains information indicating purchasing and viewing habits of said incentive user.

43. The method of claim 40, wherein said step of awarding incentives includes awarding a first predetermined value of said incentives to an incentive user for visiting a site of said incentive issuer.

44. The method of claim 40, wherein said step of awarding incentives includes awarding a second predetermined value of incentives to an incentive user for purchasing an item.

45. The method of claim 40, wherein said incentive issuer sets said predetermined value of said incentives to be awarded during an awarding step.

46. The method of claim 40, further including the step of electronically redeeming said incentives over said electronic computer network at said incentive user's discretion.

47. The method of claim 40, further including the steps of:
distributing said incentives to an incentive issuer; and
recording, in said incentive administration server, data identifying said incentives that were distributed.

48. The method of claim 40, wherein said redeeming is performed over said network by said incentives administration server.

49. The method of claim 40, wherein said redeeming is performed over said network by said incentive issuer.

50. The method of claim 40, wherein the awarding step comprises awarding a printed incentive which may be electronically registered to convert said printed incentive to an electronic incentive.

51. The method of claim 40, wherein said awarding step comprises the steps of:
displaying a membership symbol on a site of said incentive user; and
electronically awarding said incentive to said incentive user when a non-incentive user selects said membership symbol to access said incentives administration server.

52. The method of claim 40, further including the steps of:
displaying an incentive logo design in association with an advertisement on said computer network;
permitting said incentive user to visit said incentive issuer's site by electronically accessing said advertisement; and
permitting said awarding upon the user's selection of the displayed electronic incentive symbol at said issuer's site.

53. An electronic incentive method which offers an incentive to an incentive user over an electronic computer network, comprising the steps of:
distributing said incentives to an incentive issuer;
recording, in said incentives administration server, data identifying said incentives that were distributed;
electronically registering over said network an incentive user and granting said incentive user an electronic incentive account in an incentives administration server;
displaying a representation of said incentives at a site of an incentive issuer;
electronically awarding over said network a predetermined value of incentives to said incentive user upon access of said site of said incentive issuer and upon selection of a displayed electronic incentive representation;
electronically crediting over said network an electronic incentive users account of said registered incentive user in said incentives administration server; and
electronically redeeming said incentives from an incentive issuer, over said network;
wherein said registered incentive user may accumulate and redeem said electronic incentive.

54. The method of claim 53, wherein the step of electronically registering said incentive users includes gathering incentive user information.

55. The method of claim 53, wherein said incentive user information contains information regarding the purchasing and viewing habits of said incentive user.

56. The method of claim 53, wherein said step of awarding incentives includes awarding a first predetermined value of said incentives to an incentive user visiting a site of said incentive issuer.

57. The method of claim 53, wherein said step of awarding incentives includes awarding a second predetermined value of incentives to an incentive user purchasing an item.

58. The method of claim 53, wherein the awarding step comprises awarding a printed incentive which may be electronically registered to convert said printed incentive to said electronic incentive.

59. The method of claim 53, wherein said redeeming is performed by said incentive issuer.

60. An electronic incentive method permitting an incentive user to obtain electronic incentives from a incentive issuer, including the steps of:
selecting an electronic incentive symbol on said incentive issuer's site;
obtaining incentive user information from a computer network browser of said incentive user;
determining whether said incentive issuer has said electronic incentives available to issue by comparing the amount of incentives issued by said incentive issuer with a total amount of incentives allocated to the issuer;
determining whether said incentive user is eligible to receive said electronic incentives by verifying that said incentive user is a registered incentive user;
determining whether an incentive user identifier has been received from said browser of said incentive user;
prompting for said incentive user identifier if said incentive user identifier has not been received; and
adding a predetermined award value of said electronic incentives to a cumulative incentive total of said incentive user.

61. The method of claim 60, further including the step of determining if said incentive user is eligible to receive an electronic incentive award by computing a time period since said incentive user last received said electronic incentive award and comparing said time period to a predetermined time period.

62. The method of claim 60, wherein said incentive user is prompted about whether the incentive user desires to have said electronic incentive award given to another incentive user as designated by said incentive user.

63. The method of claim 60, wherein during said step of determining whether an incentive user identifier has been received, if said incentive user identifier has been received said incentive user identifier is displayed to said incentive user along with a message stating that said incentive user will be awarded said electronic incentive award.

64. The method of claim 60, wherein at a conclusion of said method a current electronic incentive total of said incentive user is displayed to said incentive user.

65. An electronic incentive method which incorporates a printed incentive with an electronic incentive on an electronic computer network, comprising the steps of:
connecting to an incentive administration application;
communicating an incentive identifier to said incentives administration application;
verifying said identifier is authentic; and
crediting said incentive to an incentive user's account.

66. The method of claim 65, wherein said incentive administration application is accessible through an incentive administration server.

67. The method of claim 65, wherein said incentive identifier is initially concealed on said printed incentive with removable concealing means.

68. The method of claim 65, wherein said printed incentive contains the site address of an incentive issuer and said incentive administration application is accessible through the site of said issuer.

69. An electronic on-line advertisement enhancement method comprising the steps of:
displaying an electronic incentive symbol on a node on a computer network;
electronically awarding over the network an incentive to an incentive user upon selection of said electronic incentive symbol; and
displaying an advertisement to the incentive user upon the user's selection of said electronic incentive symbol.

70. The method of claim 69, wherein the advertisement is a pop-up window displaying a message to the incentive user.

71. The method of claim 69, wherein the advertisement is a banner advertisement.

72. The printed incentive of claim 18, which also comprises the site address of an incentive issuer printed on said incentive.
